(19) United States
(12) Patent Application Publication
(10) Pub. No.: US 2018/0203829 A1
(43) Pub. Date: Jul. 19, 2018

(54) AUTOMATIC UPDATED DOCUMENT PROMPT METHOD

(71) Applicant: Fujian Foxit Software Development Joint Stock Co., Ltd., Fuzhou, Fujian (CN)

(72) Inventor: Tingting ZHANG, Beijing (CN)

(21) Appl. No.: 15/743,343

(22) PCT Filed: Jul. 21, 2016
(86) PCT No.: PCT/CN2016/000409

§ 371 Date: Jan. 10, 2018

(30) Foreign Application Priority Data
Jul. 22, 2015 (CN) 201510434134.9

(51) Int. Cl. G06F 17/22; G06F 8/71

(52) U.S. Cl. CPC G06F 17/2288; G06F 17/30011; G06F 8/71; G06F 17/2211

(57) ABSTRACT

Disclosed is an automatic updated document prompt method. The method uses a document identifier, a cloud server, and a JavaScript client program to realize an automatic prompt of an updated document. After a document author develops a latest-version document, a version characteristic value of the latest-version document only needs to be saved in a document and the cloud server, so that a receiver can be automatically prompted to perform an update when opening the document. A conflict of using different versions of a document can be reduced, thereby considerably enhancing working efficiency of a document author and a receiver.

### FIELD

The present invention relates to a technical field of computers, and in particular, to a technical field of a method of automatically prompting an updated document version.

### BACKGROUND

When multiple users jointly employ one document, a document author generally uploads the document to a cloud server, and provides a download link to other receivers. After the document author updates the document, it is necessary to the document author to proactively notify the receivers that the document has been updated, so that the receivers download and receive a the latest document version updated for the last time in time to avoid a version conflict. The above method of prompting an updated document version requires the document author to proactively notify the receivers each time when the document is updated, so that the users download and receive the latest document version updated for the last time in time. The prompt method is not convenient for both the document author and the receivers, and leads to poor interconnectivity between the document author and the receivers and low collaborative efficiency thereof.

### SUMMARY

The present invention provides a method of automatically prompting an updated document version to proactively prompt a receiver when a document is version updated.

In order to achieve the above purpose, the present invention provides a method of automatically prompting an updated document version, wherein the document is created, opened and modified by a specified application program. The method includes the following steps:

S1: creating a document by using the application program, inserting a JavaScript client program into the document, and placing a document identifier in the document, wherein an access address of a cloud server is stored in the document identifier;

S2: the application program sending a assignment request for a document number and an version characteristic value to the cloud server according to the access address of the cloud server in the document identifier;

S3: the cloud server receiving the assignment request for the document number and the version characteristic value sent by the application program, and returning a globally unique document number and a version characteristic value to the application program, and the cloud server also storing the globally unique document number and the version characteristic value;

S4: the application program receiving the globally unique document number and the version characteristic value, and inserting them into the document identifier;

S5: a document author providing the document generated by the above step(s) for a receiver;

S6: after the document author modifies the document, the application program sending a assignment request for the version characteristic value to the cloud server;

S7: the cloud server receiving the assignment request for the version characteristic value sent by the application program, and returning a new version characteristic value to the application program, wherein the new version characteristic value is different from the version characteristic value(s) assigned each time in the past; the application program receiving the new version characteristic value and saving the new version characteristic value in the document identifier; and the cloud server also saving the new version characteristic value;

S8: the receiver opening the document received in the step S5 by using the application program;

S9: the JavaScript client program accessing the cloud server according to the access address of the cloud server in the document identifier of the document, and sending to the cloud server the globally unique document number in the document and the version characteristic value saved in the document identifier for the last time;

S10: the cloud server retrieving the version characteristic value saved for the last time according to the received globally unique document number, comparing it with the received version characteristic value, and if the retrieved version characteristic value and the received version characteristic value are inconsistent, returning to the JavaScript client program a query result that the document versions are inconsistent; and

S11: the JavaScript client program receiving the query result that the document versions are inconsistent, and presenting a document update prompt message to the receiver via the application program.

In one embodiment of the present invention, the document is a PDF document.

In one embodiment of the present invention, in the step S11, the application program presents the document update prompt message to the receiver via a popup box.

In one embodiment of the present invention, the step S6 and the step S7 are cyclically executed at least one time before the step S8 is executed.

In one embodiment of the present invention, the cloud server also stores the latest document version updated for the last time, and the method further includes the following step after step S11:

S12: the application program sending a document version update request to the cloud server, the cloud server receiving the document version update request and sending the latest document version updated for the last time to the application program, and the application program updating the document to the latest version.

In order to achieve the above purpose, the present invention also provides another automatic updated document prompt method, wherein the document is created, opened and modified by a specified application program. The method includes the following steps:

S1: creating a document by using the application program, inserting a JavaScript client program into the document, and placing a document identifier in the document, wherein an access address of a cloud server is stored in the document identifier;

S2: the application program sending a assignment request for a document number to the cloud server according to the access address of the cloud server in the document identifier;

S3: the cloud server receiving the assignment request for the document number sent by the application program, and returning a globally unique document number to the application program, and the cloud server also storing the globally unique document number;

S4: the application program receiving the globally unique document number, and inserting it into the document identifier;

S5: the application program generating a version characteristic value and inserting it into the document identifier;

S6: the application program sending the version characteristic value to the cloud server, and the cloud server storing the version characteristic value;

S7: a document author providing the document generated by the above step(s) for a receiver;

S8: after the document author modifies the document, the application program generating a new version characteristic value and inserting it into the document identifier, wherein the new version characteristic value is different from the version characteristic value(s) generated each time in the past;

S9: the application program sending the new version characteristic value to the cloud server, and the cloud server storing the new version characteristic value;

S10: the receiver opening the document received in the step S7 by using the application program;

S11: the JavaScript client program accessing the cloud server according to the access address of the cloud server in the document identifier of the document, and sending to the cloud server the globally unique document number in the document and the version characteristic value generated for the last time;

S12: the cloud server retrieving the version characteristic value saved for the last time according to the received globally unique document number, comparing it with the received version characteristic value, and if the retrieved version characteristic value and the received version characteristic value are inconsistent, returning to the JavaScript client program a query result that the document versions are inconsistent; and

S13: the JavaScript client program receiving the query result that the document versions are inconsistent, and presenting a document update prompt message to the receiver via the application program.

In one embodiment of the present invention, the document is a PDF document.

In one embodiment of the present invention, in the step S13, the application program presents the document update prompt message to the receiver via a popup box.

In one embodiment of the present invention, the step S8 and the step S9 are cyclically executed at least one time before the step S10 is executed.

In one embodiment of the present invention, the cloud server also stores the latest document version updated for the last time, and the method further includes the following step after step S13:

S14: the application program sending a document version update request to the cloud server, the cloud server receiving the document version update request and sending the latest document version updated for the last time to the application program, and the application program updating the document to the latest version.

By means of the present invention, an automatic prompt of an updated document is realized. After a document author develops a latest-version document, a version characteristic value of the latest document version updated for the last time only needs to be saved in a document and the cloud server, so that a receiver can be automatically prompted to perform an update when opening the document. A conflict of using different versions of a document can be reduced, thereby considerably enhancing working efficiency of a document author and a receiver.

### DETAILED DESCRIPTION

The technical solutions in the embodiments of the present invention are clearly and completely described below. Obviously, the described embodiments are only some but not all of the embodiments of the present invention. Based on the embodiments of the present invention, all of other embodiments obtained by those skill in the art without contributing inventive work shall fall within the protection scope of the present invention.

The present invention provides a method of automatically prompting an updated document version to proactively prompt a receiver when a document is updated, wherein the document is created, opened and modified by a specified application program. The method includes the following steps:

S1: creating a document by using the application program, inserting a JavaScript client program into the document, and placing a document identifier in the document, wherein an access address of a cloud server is stored in the document identifier,

wherein the document may be a PDF document or other documents in frequently-used formats, such as a WORD document, but the present invention is not limited thereto. And, when the document is created, a JavaScript client program is inserted into the document. The inserted JavaScript client program is integrated with the document, therefore, a repeated insertion is not required in each subsequent modification operation of the document. The inserted JavaScript client program is used for performing data exchange with the cloud server;

S2: the application program sending a assignment request for a document number and an version characteristic value to the cloud server according to the access address of the cloud server in the document identifier,

wherein the application program can read the access address of the cloud server in the document identifier and send the assignment request for the document number and the version characteristic value to the cloud server according to the address;

S3: the cloud server receiving the assignment request for the document number and the version characteristic value sent by the application program, and returning a globally unique document number and a version characteristic value to the application program, and the cloud server also storing the globally unique document number and the version characteristic value,

wherein the globally unique document number is used for uniquely specifying the document; and after the document is subsequently modified, the globally unique document number does not change, and the version characteristic value is used for indicating the current version of the document;

S4: the application program receiving the globally unique document number and the version characteristic value, and inserting them into the document identifier;

S5: a document author providing the document generated by the above step(s) for a receiver,

wherein the document received by the receiver at this moment is the document created initially, and correspondingly, the version characteristic value of the document is the first version characteristic value of the document;

S6: after the document author modifies the document, the application program sending a assignment request for a version characteristic value to the cloud server;

S7: the cloud server receiving the assignment request for the version characteristic value sent by the application program, and returning a new version characteristic value to the application program, wherein the new version characteristic value is different from the version characteristic value(s) assigned each time in the past; the application program receiving the new version characteristic value and saving the new version characteristic value in the document identifier; and the cloud server also saving the new version characteristic value,

wherein after the document is modified by the document author, the newest version characteristic value is saved in the document identifier and the cloud server, and the old version characteristic value is not deleted from the document identifier and the cloud server, in order to facilitate the document author or the user in viewing the document update process in a subsequent process;

S8: the receiver opening the document received in the step S5 by using the application program;

S9: the JavaScript client program accessing the cloud server according to the access address of the cloud server in the document identifier of the document, and sending to the cloud server the globally unique document number in the document and the version characteristic value saved in the document identifier for the last time;

S10: the cloud server retrieving the version characteristic value saved for the last time according to the received globally unique document number, comparing it with the received version characteristic value, and if the retrieved version characteristic value and the received version characteristic value are inconsistent, returning to the JavaScript client program a query result that the document versions are inconsistent,

wherein if the version characteristic value saved in the cloud server for the last time is inconsistent with the version characteristic value stored in the document for the last time, it is indicated that the document author has updated the document and the user has not updated the document;

S11: the JavaScript client program receiving the query result that the document versions are inconsistent, and presenting a document update prompt message to the receiver via the application program,

wherein the application program may present the document update prompt message to the receiver via a popup box, and may also present the document update message to the receiver in other intuitive forms,

wherein the step S6 and the step S7 are cyclically executed at least one time before the step S8 is executed, that is, the document author may modify the document multiple times, and the version characteristic value(s) modified each time is saved in the document identifier and the cloud server, and

wherein the cloud server may also store the latest document version updated for the last time, and at this moment, the method further includes the following step after step S11:

S12: the application program sending a document version update request to the cloud server, the cloud server receiving the document version update request and sending the latest document version updated for the last time to the application program, and the application program updating the document to the latest version.

In step S12, the document may be updated to the latest version. Of course, the receiver may also update the document to the latest version by using other methods, but the present invention is not limited thereto.

The present invention also provides another automatic updated document prompt method. Unlike the previous method, the version characteristic value is no longer assigned by the cloud server, but is directly generated and inserted into the document identifier by the application program. The method includes the following steps (the same content as in the previous method will not be repeated):

S1: creating a document by using the application program, inserting a JavaScript client program into the document, and placing a document identifier in the document, wherein an access address of a cloud server is stored in the document identifier;

S2: the application program sending a assignment request for a document number to the cloud server according to the access address of the cloud server in the document identifier;

S3: the cloud server receiving the assignment request for the document number sent by the application program, and returning a globally unique document number to the application program, and the cloud server also storing the globally unique document number;

S4: the application program receiving the globally unique document number, and inserting it into the document identifier;

S5: the application program generating a version characteristic value and inserting it into the document identifier;

S6: the application program sending the version characteristic value to the cloud server, and the cloud server storing the version characteristic value,

wherein the cloud server correspondingly stores the version characteristic value and the globally unique document number of the document, so as to read the version characteristic value of the document according to the document number;

S7: a document author providing the document generated by the above step(s) for a receiver;

S8: after the document author modifies the document, the application program generating a new version characteristic value and inserting it into the document identifier, wherein the new version characteristic value is different from the version characteristic value(s) generated each time in the past,

wherein after the document is modified, the new version characteristic value is still generated by the application program;

S9: the application program sending the new version characteristic value to the cloud server, and the cloud server storing the new version characteristic value;

S10: the receiver opening the document received in the step S7 by using the application program;

S11: the JavaScript client program accessing the cloud server according to the access address of the cloud server in the document identifier of the document, and sending to the cloud server the globally unique document number in the document and the version characteristic value generated for the last time;

S12: the cloud server retrieving the version characteristic value saved for the last time according to the received globally unique document number, comparing it with the received version characteristic value, and if the retrieved version characteristic value and the received version characteristic value are inconsistent, returning to the JavaScript client program a query result that the document versions are inconsistent; and

S13: the JavaScript client program receiving the query result that the document versions are inconsistent, and presenting a document update prompt message to the receiver via the application program,

wherein in the step S13, the application program may present the document update prompt message to the receiver via a popup box.

The step S8 and the step S9 are cyclically executed at least one time before the step S10 is executed, that is, the document author may modify the document multiple times, and the version characteristic value(s) modified each time is saved in the document identifier and the cloud server,

wherein the cloud server may also store the latest document version updated for the last time, and at this moment, the method further includes the following step after step S13:

S14: the application program sending a document version update request to the cloud server, the cloud server receiving the document version update request and sending the latest document version updated for the last time to the application program, and the application program updating the document to the latest version.

In step S14, the document may be updated to the latest version. Of course, the receiver may also update the document to the latest version by using other methods, but the present invention is not limited thereto.

By means of the present invention, an automatic prompt of an updated document is realized. After a document author develops a latest-version document, a version characteristic value of the latest document version updated for the last time is only necessary to be saved in the document and the cloud server, so that a receiver can be automatically prompted to perform an update when the document is opened. A conflict of using different versions of a document can be reduced, thereby considerably a working efficiency of a document author and a receiver is enhanced.

Finally, it should be noted that the foregoing embodiments are merely intended for describing the technical solutions of the present invention, but not for limiting the present invention. Although the present invention is described in detail with reference to the foregoing embodiments, it should be understood by those skilled in the art that: the technical solutions described in the foregoing embodiments can be still amended, or some technical features therein can be equivalently replaced, and these amendments or replacements do not make the essence of the corresponding technical solutions depart from the spirit and scope of the technical solutions in the embodiments of the present invention.

1. A method of automatically prompting an updated document version, wherein the document is created, opened and modified by a specified application program, comprising:
S1: creating a document by using the application program, inserting a JavaScript client program into the document, and placing a document identifier in the document, wherein an access address of a cloud server is stored in the document identifier;
S2: the application program sending an assignment request for a document number and a version characteristic value to the cloud server according to the access address of the cloud server in the document identifier;
S3: the cloud server receiving the assignment request for the document number and the version characteristic value sent by the application program, and returning a globally unique document number and a version characteristic value to the application program, and the cloud server also storing the globally unique document number and the version characteristic value;
S4: the application program receiving the globally unique document number and the version characteristic value, and inserting the globally unique document number and the version characteristic value into the document identifier;
S5: a document author providing the document generated by the above steps for a receiver;
S6: after the document author modifies the document, the application program sending an assignment request for the version characteristic value to the cloud server;
S7: the cloud server receiving the assignment request for the version characteristic value sent by the application program, and returning a new version characteristic value to the application program, wherein the new version characteristic value is different from the version characteristic value(s) assigned each time in the past; the application program receiving the new version characteristic value and saving the new version characteristic value in the document identifier; and the cloud server also saving the new version characteristic value;
S8: the receiver opening the document received in the step S5 by using the application program;
S9: the JavaScript client program accessing the cloud server according to the access address of the cloud server in the document identifier of the document, and sending to the cloud server the globally unique document number in the document and the version characteristic value saved in the document identifier for the last time;
S10: the cloud server retrieving the version characteristic value saved for the last time according to the received globally unique document number, comparing the version characteristic value saved for the last time with the received version characteristic value, and if the retrieved version characteristic value and the received version characteristic value are inconsistent, returning to the JavaScript client program a query result that the document versions are inconsistent; and
S11: the JavaScript client program receiving the query result that the document versions are inconsistent, and presenting a document update prompt message to the receiver via the application program.

2. The method of automatically prompting the updated document version according to the claim 1, wherein the document is a PDF document.

3. The method of automatically prompting the updated document version according to the claim 1, wherein in the step S11, the application program presents the document update prompt message to the receiver via a popup box.

4. The method of automatically prompting the updated document version according to the claim 1, wherein the step S6 and the step S7 are cyclically executed at least one time before the step S8 is executed.

5. The method of automatically prompting the updated document version according to the claim 1, wherein the cloud server also stores the latest document version updated for the last time, and the method further includes the following step after step S11:
S12: the application program sending a document version update request to the cloud server, the cloud server receiving the document version update request and sending the latest document version updated for the last time to the application program, and the application program updating the document to the latest version.

6. A method of automatically prompting an updated document version, wherein the document is created, opened and modified by a specified application program, comprising:
S1: creating a document by using the application program, inserting a JavaScript client program into the document, and placing a document identifier in the document, wherein an access address of a cloud server is stored in the document identifier;
S2: the application program sending an assignment request for a document number to the cloud server according to the access address of the cloud server in the document identifier;
S3: the cloud server receiving the assignment request for the document number sent by the application program, and returning a globally unique document number to the application program, and the cloud server also storing the globally unique document number;
S4: the application program receiving the globally unique document number, and inserting the globally unique document number into the document identifier;
S5: the application program generating a version characteristic value and inserting the version characteristic value into the document identifier;
S6: the application program sending the version characteristic value to the cloud server, and the cloud server storing the version characteristic value;
S7: a document author providing the document generated by the above steps for a receiver;
S8: after the document author modifies the document, the application program generating a new version characteristic value and inserting the new version characteristic value into the document identifier, wherein the new version characteristic value is different from the version characteristic value(s) generated each time in the past;
S9: the application program sending the new version characteristic value to the cloud server, and the cloud server storing the new version characteristic value;
S10: the receiver opening the document received in the step S7 by using the application program;
S11: the JavaScript client program accessing the cloud server according to the access address of the cloud server in the document identifier of the document, and sending to the cloud server the globally unique document number in the document and the version characteristic value generated for the last time;
S12: the cloud server retrieving the version characteristic value saved for the last time according to the received globally unique document number, comparing the version characteristic value saved for the last time with the received version characteristic value, and if the retrieved version characteristic value and the received version characteristic value are inconsistent, returning to the JavaScript client program a query result that the document versions are inconsistent; and
S13: the JavaScript client program receiving the query result that the document versions are inconsistent, and presenting a document update prompt message to the receiver via the application program.

7. The method of automatically prompting the updated document version according to the claim 6, wherein the document is a PDF document.

8. The method of automatically prompting the updated document version according to the claim 6, wherein in the step S13, the application program presents the document update prompt message to the receiver via a popup box.

9. The method of automatically prompting the updated document version according to the claim 6, wherein the step S8 and the step S9 are cyclically executed at least one time before the step S10 is executed.

10. The method of automatically prompting the updated document version according to the claim 6, wherein the cloud server also stores the latest document version updated for the last time, and the method further includes the following step after step S13:
S14: the application program sending a document version update request to the cloud server, the cloud server receiving the document version update request and sending the latest document version updated for the last time to the application program, and the application program updating the document to the latest version.
